(19) United States
(12) Patent Application Publication
(10) Pub. No.: US 2004/0026936 A1
(43) Pub. Date: Feb. 12, 2004

(54) Motor vehicle door component having fiber flocking

(76) Inventors: Shawn Slovesko, Ypsilanti, MI (US); Paul R. Stevenson, Livonia, MI (US); Robert E. Ciborowski, Canton, MI (US); David A. Davies, Lake Orion, MI (US); Mack T. Moore, Oak Park, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/213,979

(22) Filed: Aug. 7, 2002

(51) Int. Cl. E05B 3/00

(52) U.S. Cl. 292/336.3

(57) ABSTRACT

A component for a door of a motor vehicle comprises a rod movable within the door, and a flocking along at least a portion of the length of the rod.

### TECHNICAL FIELD OF THE INVENTION

This invention relates generally to doors for motor vehicles, and relates more particularly to a motor vehicle door component having fiber flocking.

### BACKGROUND OF THE INVENTION

During normal operation, various components within a motor vehicle door may move out of position and strike against the door sheet metal or other components of the door. This displacement may cause noise and vibration that is not satisfactory. In order to reduce such problems, it has been proposed to shield or pad the door components with materials such as plastic, cloth, foam, rubber or felt. All of these materials require manual assembly, and often they also require other means of retention such as plastic tie wraps. Moreover, the sleeves may be easily displaced from their intended location during assembly or operation of the door.

### SUMMARY OF THE INVENTION

The present invention is a component for a door of a motor vehicle. The component comprises a rod movable within the door, and a flocking along at least a portion of the length of the rod.

Accordingly, it is an object of the present invention to provide a component of the type described above that inhibits noise in the door.

Another object of the present invention is to provide a component of the type described above that is relatively easy to assemble.

Still another object of the present invention is to provide a component of the type described above which is cost-effective.

These and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a perspective view of a door panel including components according to the present invention; and

FIG. 2 is a cross-sectional view of an alternative embodiment of the invention.

### DETAILED DESCRIPTION OF THE PRESENTLY PREFERRED EMBODIMENTS

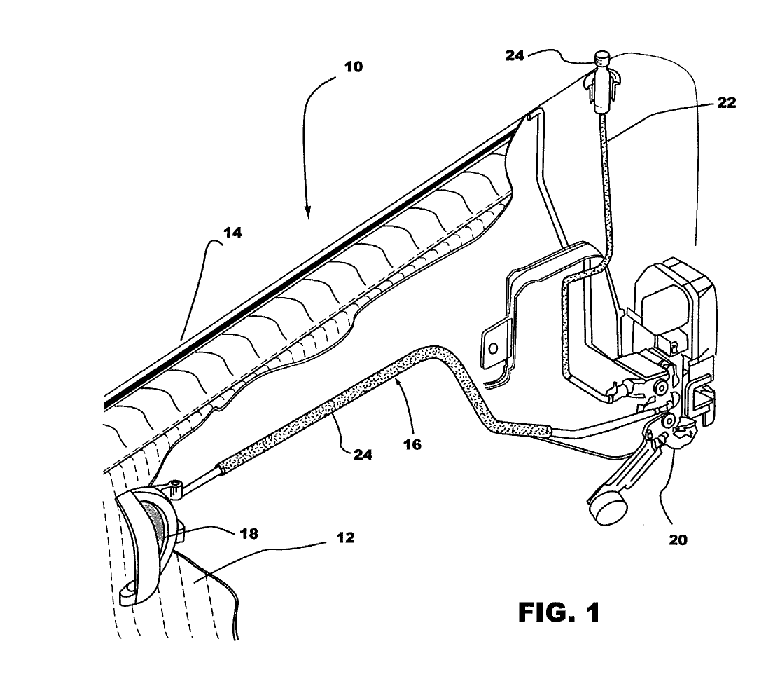

FIG. 1 shows one embodiment 10 of a door according to the present invention for a motor vehicle. The door 10 includes an interior panel 12 and an exterior panel 14. As is well known, several rods are movable within the interior panel 12 and the exterior panel 14. A door release rod 16 is connected between an inside release handle 18 and a door latch 20. A lock release rod 22 is connected between a lock knob 24 and the door latch 20 to selectively lock or unlock the door 10, as is conventional.

Either or both of the door release rod 16 and the lock release rod 22 may be provided with fiber flocking along at least a portion of their length. For instance, the door release rod 16 is preferably provided with flocking 24 along a substantial portion of its length, but the flocking does not extend all the way to either end of the door release rod. The lock release rod 22 is similarly provided with flocking 26 that extends along a substantial portion of its length, leaving exposed areas proximate the opposite ends of the lock release rod. Nylon or polyester fibers are preferred for this application.

The door components flocked in this manner are relatively easy to assemble and operate, and least in part because the flock covering does not normally move during assembly and operation of the door system. Furthermore, the flocking is resistant to moisture and deformation, and the length of the fibers can be adjusted to provide more or less protection. The fibers also damp the sound of the component itself, as well as inhibiting noise that may be generated if the component impinges against other components of the door.

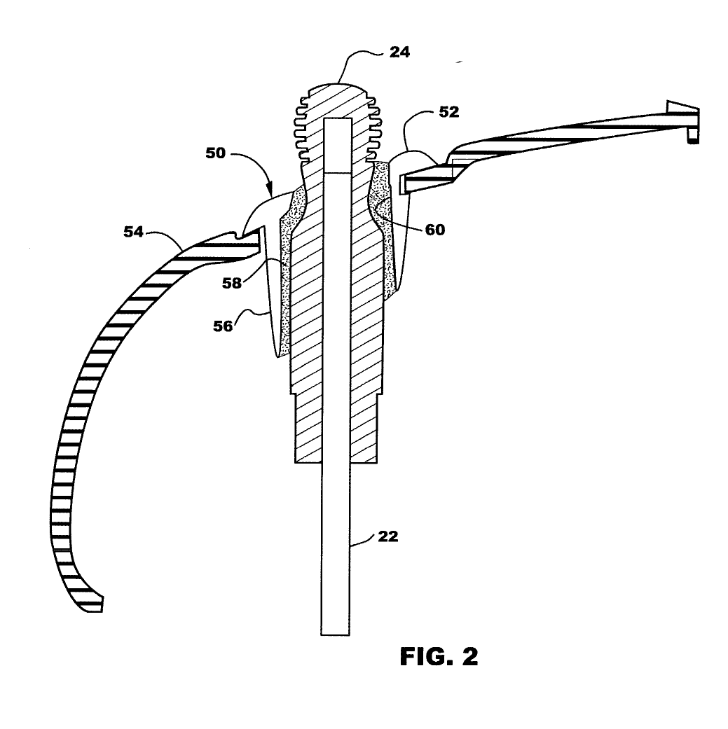

FIG. 2 shows an alternative embodiment of the present invention including a lock knob bezel 50. The lock knob bezel 50 has a flange 52 that is adapted to be mounted substantially flush with an upper surface 54 of the vehicle door, and a portion 56 that extends into the interior of the door. The lock knob 24 is situated on the upper end of the lock release rod 22, and may be translated up and down within the lock knob bezel 50. Fiber flocking 58 is disposed along at least a part of an interior surface 60 of the portion 56. As with the embodiment described above, the fiber flocking 58 is adapted to damp interference between the portion 56 and the lock knob 24.

In either embodiment, the surface to which the flocking is attached may be metal or plastic. The component to be treated is first mounted in a fixture, and an adhesive is applied. The fixture is constructed so as to control the location of the adhesive. The ends of link rods, for example, are left free of adhesive to allow the fitting of plastic clips. For components such as the lock knobs, visible class A surfaces are left free of adhesive for aesthetic reasons. An electrostatic charge is then applied to the component, which attracts the fibers. Each individual fiber sticks to the adhesive end-on, so that the fibers are arranged radially around the component.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A component for a door of a motor vehicle, the component comprising:
a rod movable within the door; and
a flocking along at least a portion of the length of the rod.

2. The component of claim 1 wherein the flocking comprises nylon fibers.

3. The component of claim 1 wherein the flocking comprises polyester fibers.

4. The component of claim 1 wherein the rod is connected to a door release.

5. The component of claim 1 wherein the rod is connected to a lock knob.

6. The component of claim 1 wherein the rod includes metal to which the flocking is attached.

7. The component of claim 1 wherein the rod includes plastic to which the flocking is attached.

8. A lock knob bezel for a motor vehicle door having a surface, the lock knob bezel comprising:
a portion extending into an interior of the door from a position generally proximate the surface, the portion having an interior surface; and
flocking disposed along at least a part of the interior surface of the portion.

9. The lock knob bezel of claim 9 further comprising a flange connected to the portion, the flange adapted to be mounted substantially flush with the surface of the vehicle door.

10. The lock knob bezel of claim 8 wherein the flocking comprises nylon fibers.

11. The lock knob bezel of claim 8 wherein the flocking comprises polyester fibers.

12. The lock knob bezel of claim 8 wherein the flocking is adapted to damp interference between the portion and a lock knob.

13. The lock knob bezel of claim 8 wherein the portion includes metal to which the flocking is attached.

14. The lock knob bezel of claim 8 wherein the portion includes plastic to which the flocking is attached.

15. A door for a motor vehicle, the door comprising:
an interior panel;
an exterior panel; and
a rod movable within the interior panel and the exterior panel, the rod having a flocking along at least a portion of its length.

16. The door of claim 15 wherein the flocking comprises nylon fibers.

17. The door of claim 15 wherein the flocking comprises polyester fibers.

18. The door of claim 15 wherein the rod is connected to a door release.

19. The door of claim 15 wherein the rod is connected to a lock knob.

20. The door of claim 15 wherein the rod includes metal to which the flocking is attached.
